(19) United States
(12) Patent Application Publication
(10) Pub. No.: US 2020/0013311 A1
(43) Pub. Date: Jan. 9, 2020

(54) ALTERNATIVE PERSPECTIVE EXPERIENTIAL LEARNING SYSTEM

(71) Applicant: Live in Their World, Inc., San Francisco, CA (US)

(72) Inventor: Robin S. Rosenberg, San Francisco, CA (US)

(21) Appl. No.: 16/506,893

(22) Filed: Jul. 9, 2019

Related U.S. Application Data
(60) Provisional application No. 62/695,667, filed on Jul. 9, 2018.

(51) Int. Cl. G09B 19/00; G06F 3/01; G09B 7/04

(52) U.S. Cl. CPC G09B 19/00; G09B 7/04; G06F 3/012; G06F 3/013

(57) ABSTRACT

There is disclosed a system for experiential learning. The system includes a virtual reality or augmented reality headset for a user to wear to experience one or more scenarios in which a user's characteristics are altered within the virtual world. These scenarios may take the form of vignettes or video-game like user experiences. Data may be collected for responses within the scenarios and may be gathered over time to enable a user or an external entity (such as a human resources department) to measure changes in the responses of the user to given scenarios.

### RELATED APPLICATION INFORMATION

This patent claims priority from U.S. provisional patent application No. 62/695,667 filed Jul. 9, 2018 entitled “Alternative Perspective Experiential Learning System”.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates to full immersion training. Specifically, this disclosure relates to utilizing augmented and virtual reality technology to display to a user a fully immersive training program directed to problems of diversity, workplace safety, workplace harassment, sensitivity, decency and more.

### Description of the Related Art

Every individual operates within society based upon numerous, somewhat intangible, characteristics. Each individual may not be consciously aware of the social cues they give off or pick up when moving throughout their day to day interactions with others. Individuals may operate from certain perspectives, and be largely unaware of the perspectives of others. A perception of a given situation or scenario involving two or more parties interacting with one another may vary wildly (e.g. one may enjoy a situation as rambunctious play, while another feels sexually harassed or condescended to). Because perception is at least in part subjective, both parties may be somewhat correct in their differing perceptions of a given scenario. Regardless, a better understanding of another's perspective may help both parties feel better understood and result in fewer inadvertent or intentional minor or major slights, hurts, or insults, or discriminatory or disrespectful acts.

To deal with these types of issues in the workplace specifically, most employees have been required to undergo some sort of training regarding how to treat others in an office setting or how to be better attuned to particular cultures, races, sexes, sexual orientations, genders or other characteristics. These trainings are often given in person, using video, or via an online teaching and testing platform. Such training is not desirable because they are one-shot “check the box” training opportunities that many employees endure rather than actually learn from. Moreover, individuals find it difficult to focus on video training. Individuals are easily distracted during online training while they are on their computer. Most importantly, these trainings make gaining empathy difficult: Topics are complicated and nuanced and perspective and empathy are difficult to learn from a sterile classroom environment. An alternative form of learning such information is via in-person training, typically in groups with coworkers. This method can feel forced and uncomfortable, and individuals who most need the training are least interested in being involved. Better empathy training and greater understanding, coupled with better measurement of the results of such learning, would be desirable.

### DESCRIPTION OF THE DRAWINGS

FIG. 1 is an overview of a system for experiential learning.

FIG. 2 is a computing device.

FIG. 3 is a functional overview of a system for experiential learning.

FIG. 4 is a flowchart for a process of scenario generation.

FIG. 5 is a flowchart for a process of interaction between a VR/AR headset and a visualization server.

FIG. 6 is a flowchart for a training session.

FIG. 7 is a flowchart for user interaction and feedback.

FIG. 8 is a flowchart for a training session with limited to no user interaction.

FIG. 9 is an example user interface.

FIG. 10 is a different example user interface.

FIG. 11 is a comparison of different perspectives in a training session.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

In order for a better experiential learning experience, particularly learning related to individual perception and experiences, full immersion in the perspectives of another is helpful. This is difficult through training sessions and classroom-style experiences. Humans learn best by doing and experiencing. The various ways of dealing with these kinds of issues have in the past included sensitivity training, diversity training, inclusion training, workplace safety training, experiential workshops, avoiding sexual harassment, avoiding a hostile work environment, emotional intelligence education, ethics education, teamwork and team-building activities, encouraging adaptability, and many more. Societal pressures also tend to socialize individuals to take these types of concerns into account, but those take time and experience to register.

The types of trainings that are typical, for example in workplace environments, such as watching videos, taking quizzes, or reading articles are less-valuable for training because they lack the experiential learning of allowing a user to feel or experience the training from the perspective of someone else. For example, one can read a great deal concerning how best to be respectful to women in the workplace, but unless someone has experienced what it is like to be a woman, or had the perspective of a woman in the workforce; it is very hard to understand what a woman in the workplace goes through, or why such training is important. The present disclosure deals with this problem by creating an immersive environment that allows a user to interact in a scenario as if they were another person or as if they were within that scenario.

For example, women on average in the United States are shorter than men. In certain situations, that height difference can manifest itself in the form of a perceived, if not actual, power disadvantage for the woman. That may place the man in a situation of “looming over” a woman, from her perspective, in such a way to be menacing. From the man's perspective, this effect may not be noticeable at all. But, if a man were able to experience this type of being “loomed” over, he may better understand why his posture or position can feel menacing or threatening to another. This is only one example among many potential examples. In some scenarios, the “thoughts” of a person interacting in the virtual world may be played to the user in a voice opposite their own. For example, if a man were taking the training course, but the individual's first-person perspective is a woman's, then any spoken thoughts may be voice acted by a woman so as to represent the woman's perspective more clearly to the man.

Description of Apparatus

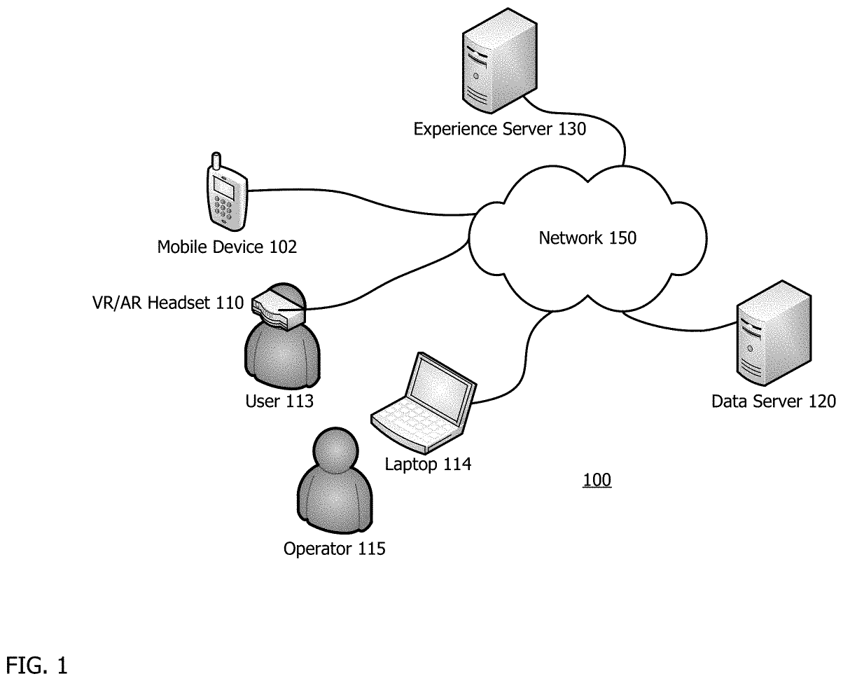

Referring now to FIG. 1 we see an overview of a system for experiential learning. The system 100 can include a mobile device 102, a VR/AR headset 110, worn or used by a user 113, a laptop 114, operated by an operator 115, a data server 120 and an experience server 130, all interconnected by a network 150.

The user 113 interacts with the VR/AR headset 110. The VR/AR headset can be any computer capable of generating an augmented reality or virtual reality training session. Such VR/AR headsets include, Oculus® Rift®, Oculus® Go™, Oculus® Quest™, HTC® Vive®, Sony® PlayStationVR®, a smartphone or computing device placed into a holder that can operate as a VR/AR headset (such as Google cardboard and a smartphone), Microsoft® HoloLens®, Magic Leap® Lightwear®, Epson® Moverio® BT-300FPV Drone Edition, Google® Glass®, Vuzix® Blade AR, Meta 2, Optinvent Ora-2, and Garmin® Varia® Vision and other variants of these devices.

Other environments that mimic those of VR/AR headsets may also be used such as specialized theaters that utilize 3-D glasses or IMAX® theater type environments. In certain instances, mixed reality environments, those that take elements from virtual reality and augmented reality may also be used. Augmented reality may also be appropriate for a training session. In augmented reality, elements of a virtually reality environment are overlaid over live images (captured by a camera) of the present, physical environment. A user looking though a piece of equipment will see both the virtual and the actual physical environment. In other instances, a regular screen such as a television, computer monitor, or smartphone screen may also be used to generate the environment, as occurs with 360- or 180-degree videos posted on YouTube or other websites.

As used herein, the term “virtual reality” means three-dimensional content that includes computer-generated images or objects. “Virtual reality” expressly includes augmented reality scenes that incorporate real images of a present location but also include one or more computer-generated characters or objects.

As used herein “computer-generated” means content that is generated by application computer processes. This may include three-dimensional models with textures applied as in traditional computer game design, but also can include 360- or 180-degree video played back through a computing device, or six-degrees-of-freedom (6Dof) video similarly played.

As used herein, the term “segment” means an experience in virtual reality of an interaction, a situation, or a location, typically with other people, that involves some experience from the perspective of another. An example segment may show an in-office interaction between multiple office individuals from the perspective of a secretary or a CEO.

As used herein, the term “scenario” means a virtual reality experience, which may take place over several segments, that is focused upon training or learning of a user from the perspective of another. An example scenario may show several different interactions over several different issues for the same secretary or CEO in an in-office environment. A scenario is created to teach another about a perspective that may be different from a viewer's perspective. Virtual reality enables the scenarios to show that user as someone other than themselves.

The mobile device 102 may be optionally included as one way to begin experiences (e.g. through operation by the operator 115 or the user 113) or to provide input for the experiences. For example, the VR/AR headset 110 may not incorporate any controller, but the user 113 may be asked to provide text input or select from a number of options. In such a case, a mobile device, like mobile device 102 may be used. In some cases, the mobile device 102 may form a part of the VR/AR headset 110 itself (e.g. products like the Google® Daydream® may be used).

The laptop 114 (or another computing device) may be used by the operator 115 to control or administer the experiences to the user 113 using the VR/AR headset 110. The operator 115 can be another person such as an HR administrator at an office, a counselor or a friend of the user 113. The operator 115 is someone that directs the system 100 and any associated scenarios or trainings to be set up a certain way. As discussed later herein, there may be certain options and definitions for components of the system 100 that can be either inputted or selected by the user 113 or an operator 115 who is distinct from the user 113.

The VR/AR headset 110 may communicate through the network 150, with other devices such as the mobile device, 102, the laptop 114, the data server 120, and the experience server 130. The VR/AR headset 110 may work alone or in concert with other devices attached to network 150, to generate a training session, experience, or scenario for a user 113. Network 150 may also be or include the internet and/or a private network created from the linking of multiple devices.

VR/AR headset 110 may work with other devices connected to the network 150 in a number of ways. User 113 may be asked to fill out a survey or to access or create a personal profile before or during a training session. Accessing this information may be done through the AR/VR headset 110 or could be done through the mobile device 102, or the laptop 114. When a scenario (discussed later on) is generated and displayed to user 113, the generation of the scenario may be accomplished by data shared between the experience server 130, the data server 120, and the VR/AR headset 112.

The data server 120 is a computing device that stores and operates upon data input by the user 113 and/or the operator 115. This data may include personal information for the associated user 113, the particular experiences or scenarios undertaken by the user 113, and the results of any input by the user 113 (e.g. responses to scenarios or the time spent on scenarios or other data about the user's responses to scenarios). The data server 120 may be accessible to the operator 115 to see the results, either for that user 113, or anonymized for a group of users, and to confirm that the user 113 has completed a particular scenario or experience.

The experience server 130 is a repository of scenarios for the user 113. The experience server may store these in a proprietary format such as 360- or 180-degree video, or six-degrees-of-freedom-video. The scenarios or experiences may play much like a video with limited or no interaction, or may play as a game or choose-your-own-adventure experience where the user 113 may interact with individuals within the scenario or experience and the results of those interactions may be shown to the user 113. These scenarios or experiences may be served to the VR/AR headset 110 from the experience server 130.

In some cases, the functions of the laptop 114, the data server 120 and the experience server 130 may be integrated into a single device or multiple devices, or into the VR/AR headset 110 itself. For example, a separate laptop 114 and data server 120 or a separate data server 120 and experience server 130 may not be necessary. Their functions may be combined in such cases. The particular way in which the components are integrated may vary from case to case.

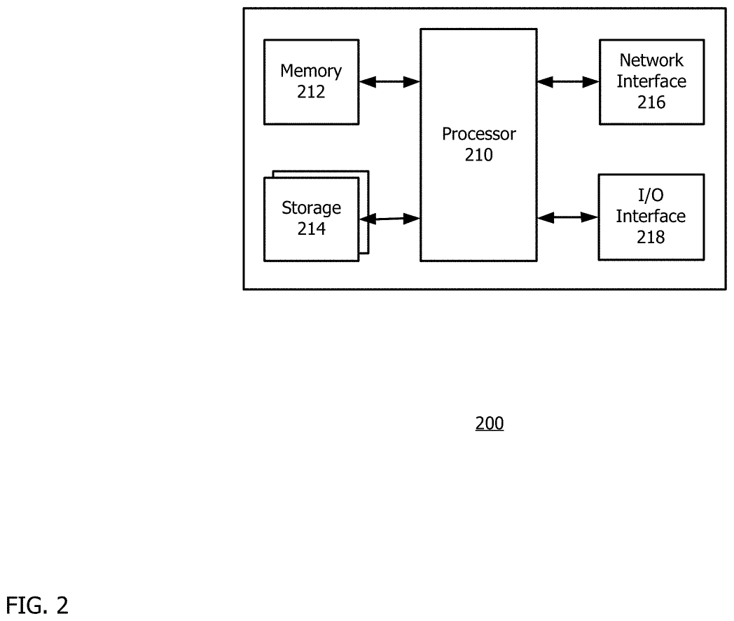

Referring to FIG. 2, a computing device is shown. The mobile device 102, the VR/AR headset 110, the laptop 114, the data server 120, and the experience server 130 (FIG. 1) are or may include computing devices. The computing device 200 may have a processor 210 coupled to a memory 212, storage 214, a network interface 216 and an I/O interface 218. The processor may be or include one or more microprocessors and application specific integrated circuits (ASICs).

The processor 210 may be a general-purpose processor such as a CPU or a specialized processor such as a GPU. The processor 210 may be specially designed to incorporate unique instruction sets suited to a particular purpose (e.g. inertial measurement for generation of movement tracking data for AR/VR application).

The memory 212 may be or include RAM, ROM, DRAM, SRAM and MRAM, and may include firmware, such as static data or fixed instructions, BIOS, system functions, configuration data, and other routines used during the operation of the computing device 200 and processor 210. The memory 212 also provides a storage area for data and instructions associated with applications and data handled by the processor 210. As used herein, the word memory specifically excludes transitory medium such as signals and propagating waveforms.

The storage 214 may provide non-volatile, bulk or long-term storage of data or instructions in the computing device 200. The storage 214 may take the form of a disk, tape, CD, DVD, or other reasonably high capacity addressable or serial storage medium. Multiple storage devices may be provided or available to the computing device 200. Some of these storage devices may be external to the computing device 200, such as network storage or cloud-based storage. As used herein, the word storage specifically excludes transitory medium such as signals and propagating waveforms.

The network interface 216 may be configured to interface to a network such as network 150 (FIG. 1). The I/O interface 218 may be configured to interface the processor 210 to peripherals (not shown) such as displays, keyboards printers, VR/AR headsets, additional computing devices, controllers, and USB devices.

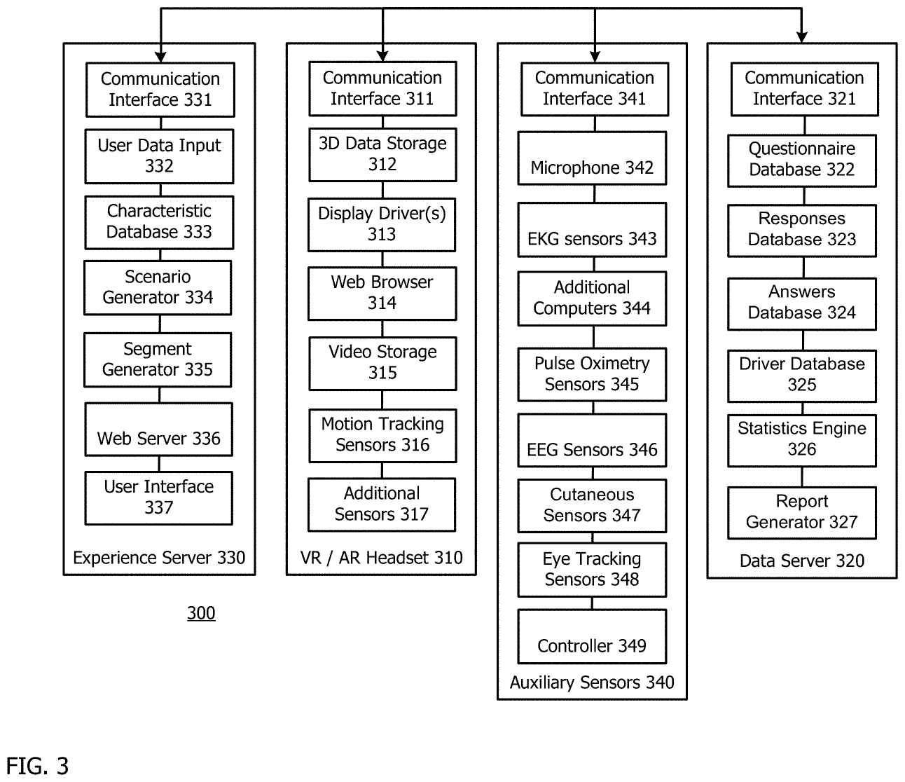

Referring now to FIG. 3 an overview of a system for experiential learning is shown. The system 300 includes the same VR/AR headset 310, data server 320 and experience server 330 seen in FIG. 1. In addition, some auxiliary sensors 340 may be present.

The experience server 330 includes a communications interface 331, user data input 322, characteristic database 333, scenario generator 334, segment generator 335, web server 335, and a user interface 337. As indicated above, the experience server 330 primarily stores and serves the scenarios or experiences to the user.

The communication interface 331 enables the experience server 330 to communicate with the other components of the system 300. The communications interface may be specialized, suitable only for the system, or may be generalized, based upon standards and reliant upon those standards to communicate data between the various components.

The user data input 332 is used to store any data input by the user during the process of starting or participating in a given scenario or experience. The types of data stored in user data input 332 may be any data imputed by a user when they are wearing a headset or data inputted before such as scores on Gender-Career Implicit Association Test or other external or internal test data.

The experience server 330 may also be equipped with a characteristic database 333. The characteristic database 333 contains information necessary to render various VR/AR user types. User types may be similar to “skins” found in video games. A user appearing in the VR/AR world will often have different features from what they have in real life such as skin color, voice, mental voice, height, weight, and many others. For example, a user may have hands or feet or clothing or a face or hair (in a mirror) that may appear within a scenario. In some cases, this may merely be pre-recorded 360- or 180-degree video for that scenario, but in other cases, this may be an actual computer model for that particular characteristic set being trained upon. So, an individual may appear as a woman, as someone of color, as missing a limb, or having some other characteristic within the scenario or experience. These different features may be stored in the characteristic database 333. File types that may be stored in the characteristic database include object files (.obj), CAD files (.cad), VRML files (.wrl, .wrz), MP4, MP3, VLC, MPEG, and other files capable of storing visual data.

The experience server 330 may also include the scenario generator 334. The scenario generator 334 contains the data necessary to create the scenario itself, such as the surroundings and the audio for the voice acting (if any) or any sound effects. This data may be stored as 360- or 180-degree video, six-degrees-of-freedom video, or may be stored as three-dimensional computer image files with associated textures. The scenario generator may also contain textures used to create the VR/AR “physical” world. When set in the real world, but enhanced through augmented reality, these textures and models may be used to create, for example, a character or an object (e.g. a chair or desk) that appear in the real world. A scenario generator 334 may also hold details regarding a scenario such as a script for the scenario containing what people in the AR/VR world say and think to one another.

Next, the experience server 330 may include a segment generator 335. The segment generator 335 is similar to the scenario generator 334 except that it contains shorter parts of a scenario. In some instances, the segment generator may contain short clips in MP4, MP3, MPEG, FLV or other audiovisual file formats that are only a part of a scenario. The scenario generator may be a cutscene or a short bit of dialogue or some other sub-part of the overall scenario or environment. In other embodiments an entire scenario may be stored in one large segment file.

The experience server 330 may also contain or be in connection with a web server 336. The web server 336 can provide data to the components of the experience server or even take data from the components and pass it to other parts of the system. Additionally, the web server 336 may provide a user interface 337 to a user while they are using a VR/AR headset. If the web server 336 does not provide a user interface 337, then the user interface 337 may be generated separately.

Turning now to VR/AR headset 310, which is one of the VR/AR headsets discussed above with reference to FIG. 1. The VR/AR headset 310 is worn by a user when they are engaged in a virtual reality training session. The VR/AR headset 310 contains a communications interface 311, three-dimensional data storage 312, display driver(s) 313, a web browser 314, video storage 315, motion tracking sensors 316, and additional sensors 317. The VR/AR headset 310 may also be in communication with experience server 330, the auxiliary sensors 340, and the data server 320.

First, the VR/AR sensor may have a communication interface 311. The communication interface 311 offers substantially the same function as the communications interface 331 described above. That discussion will not be repeated here. However, this communications interface 331 may also include one or more interfaces interacting with the virtual world. The communication interface 311 may contain microphones and speakers that an operator may use to communicate with the user while the training session is running.

The VR/AR headset may contain three-dimensional data storage 312. In some instances, the three-dimensional data storage 312 may be found on the experience server (or both), but in others it may be found in the AR/VR headset itself. The three-dimensional data storage 312 contains information necessary to render objects in the AR/VR world including information regarding the training session, scenario and segment. The three-dimensional data storage 312 may be merely temporary storage where scenarios or segments provided by the experience server 330 are stored for viewing on the VR/AR headset 310.

Next, the VR/AR headset 310 contains display driver(s) 313. A display driver 313 is a piece of software that assists in displaying an image on the VR/AR headset.

The VR/AR headset 310 may also contain a web browser 314. The web browser 314 may be a conventional web browser a user may use to browse the internet such as Google® Chrome® or Brave® browser, but it may also function to allow the VR/AR headset 310 to exchange data with other components.

The VR/AR headset 310 may also contain video storage 315. Video storage 315 can be used to store data related to rendering a training sessions, scenario, and segments. This may be typical video file data for 360- or 180-degree video, but it may also be specialized formats.

Headset 310 also includes motion tracking sensors 316 which are commonly implemented in AR/VR headsets using an IMU (inertial measurement unit). These motion tracking sensors 316 are likely in the headset but could also or instead be separate from the headset 310. So-called inside-out (reliant primarily upon sensors in the headset looking outward) or so-called outside-in (reliant primarily upon external sensors tracking movement of the headset in free space) tracking may both be used. In other instances, a combination of outside-in and inside-out tracking may be used.

Additional sensors 317 can also be used in the VR/AR headset. These sensors 317 may be additional cameras than are used in the VR/AR headset or different cameras entirely such as infrared, thermal and night vision cameras.

Auxiliary sensors 340 are a group of sensors that may provide extended functionality to the VR/AR headset 310. The auxiliary sensors 340 may include the communications interface 341, a microphone 342, EKG sensors 343, additional computers 344, pulse oximetry sensors 345, EEG sensors 346, cutaneous sensors 347, eye tracking sensors 348, and a controller 349. These are generally optional, but some may be required for use of certain scenarios or testing procedures. As above, the communications interface 341 provides similar functions to those described with reference to the VR/AR headset 310 and the experience server 330. Auxiliary sensors 340 are sensors that may detect other signals from a human user using the system 300. The auxiliary sensors 340 may be integral to the VR/AR headset 310 or separate from it. The auxiliary sensors 340 may be useful because they allow the system 300 to gather additional data from the user that may be further used to gain useful incites on how users are responding to training sessions, scenarios, or experiences.

The first such auxiliary sensor 340 is a microphone 342. The microphone 342 may be either in a VR/AR headset or outside of the headset. The microphone 342 can be used to pick up audio from a user or external to the user. Audio may come in the form of verbal commands such as when a user affirmatively speaks to input data into the system, such as when a user picks a specific answer or speaks to another AR/VR person. Additionally, the microphone 342 may be used to pick up noise not generally associated with speech such as gasps, cries, mutters or other verbal emotional states that may be processed later.

Auxiliary sensors 340 may also include EKG sensors 343. An EKG sensor may come in the form of any electrode capable of measuring and producing an electrocardiogram. An electrocardiogram is graph of voltage versus time of the heart. Electrodes are placed on a user's skin. The EKG may be integrated into the headset such that it contacts the user's skin while the user is wearing the VR/AR headset 310 to track heart rate and voltage data. The data from the EKG can later be used to make inferences such as when a user was feeling stress or if a person felt angry, confused, or upset.

Additional computers 344 may also be included. In certain instances, an auxiliary sensor 340 may collect a high amount of data (some sensors may generate up to a terabyte of data per run) and an additional computer 344 may be required to process the high amount of data. In other instances, it may simply be more convenient for additional sensors 344 to run with another computer connected to the entire system.

Next, a pulse oximetry sensor 345 may also be added to the system. These sensors are often used to measure a person's blood oxygen levels and pulse rate. The measured pulse rate can be associated with a user's well-being and stress level. For example, when a user sees an awkward part of a scenario, their pulse may be raised, and the raised pulse may be measured by the sensor 345. An increased pulse rate may actually be a positive experience, meaning that a user is recognizing that a particular scenario is stressful or negative. A high pulse rate at certain parts at a scenario can also be correlated to how sensitive a user is to certain social interactions. A lack of high pulse rate may also be correlated with a lack of empathy in other cases. Blood oxygen levels may not be used as much as pulse rate, however the data collected regarding blood oxygen may still be used to find correlations between blood oxygen levels and social interactions.

EEG sensors 346 may be found either in an AR/VR headset or be located outside the headset. EEG sensors are electrophysiological sensors capable of measuring electric signals generated from the brain. A single EEG sensor may also be known as Electroencephalography. For the EEG sensors 346 to work, electrodes may be placed on the scalp or other parts of a user's head. The position of the electrodes and adjustments made by a technician can measure electrical signals from certain parts of the brain. EEG signals can be measured at certain parts of the brain and be associated with certain thoughts and emotions. Additionally, the EEG signals may be studied later on to see what parts of the brain experienced what signals during certain parts of the training session.

Cutaneous sensor 347 may also be connected to the system. Note a cutaneous sensor 347 can be classified as any of the aforementioned sensors that attach to a user's skin, or other types of sensors that attach to the skin. Other cutaneous sensors 347 include sweat/perspiration detectors, hormone detectors, and skin conductance sensors (electrodermal sensors). So long as an electrode is attached to the skin, and the skin or body generates an electrical signal that can be read, such an electrode may be used as a sensor and attached to the system. These signals may include activation of certain facial muscles. Data from such sensors may be integrated into any results from a user's participation in a scenario or experience.

The eye tracking sensors 348 may track movement of the user's eye. These types of sensors are typically incorporated into the interior of the VR/AR headset 310 and rely upon a camera or cameras, both RGB and infrared in particular to track the gaze vector for each user's eye. This information may prove useful to note when a user is not paying attention or when a user is averting his or her eyes from a difficult scenario. That type of data may prove helpful in indicating discomfort or comfort with a given scenario or experience.

A controller 349 may also be connected to the system. A controller 349 is any device a user may interact with that generates an electronic signal that may be read and recorded by a computer. Controllers include conventional gaming controller such as may be used for an Xbox®, HTC® Vive® or Oculus® Touch® controller. A controller may also be peripherals conventionally plugged into a computer such as a keyboard or mouse. Still, other training scenarios may require a combination of controllers or their own proprietary controller for allowing a user to generate and input signals. The controllers may provide motion data using an IMU to simulate waving or reaching out or shaking hands and similar behaviors within a scenario or experience. In other instances, a tablet computing device or mobile smartphone may also be used as a controller. Controllers may be connected via wire or wireless (e.g. Bluetooth) connection.

Next, the system 300 includes a data server 320. The data server 320 includes a communication interface, a questionnaire database 322, a responses database 323, an answers database 324, a driver database 325, a statistics engine 326, and a report generator 327. The data server 320 may also contain some of the same elements as found in the experience server 330 or VR/AR Headset 310.

The communications interface 321 has much the same function as the communications interfaces 311, 331, and 341 described above. Those discussions will not be repeated here.

The data server 320 may contain a questionnaire database 322. Questionnaire database 322 may contain questions given to a user before they begin a training session. It may also include full tests such as the Gender-Career Implicit Association Test (IAT), Gender-Work Issues Test designed by the inventor hereof, or other tests that may be pre-administered or the results of those tests for a given user that were previously administered to a user or that will be or were taken before or after a training session. In other instances, a user may be given questions while in the midst of a scenario or experience. In either case, those questions and the results may be stored in the questionnaire database 322.

A responses database 323 may also be included in the data server 320. The responses database 322 holds data relating to responses a user has given during a training session, scenario, or experience. The responses database 322 may also hold data related to responses a user has answered previously such as on tests taken before a training session, scenario, or experience and may store answers and responses given during the administration of a previous training session, scenario, or experience.

An answers database 324 may also be present. The answers database 324 contains a bank of answers that may be given in response to the questionnaire database 322. Often times data from response database 323 will be compared to data in the answer database 324. During a training session there may be times when in order to proceed through the training, a user will have to give a correct response, or the session will repeat. Or, a series of correct interactions may be required before the process can continue. The determination of what constitutes a correct response occurs when values from the questionnaire database 322, responses database 323 and answers database 324 are compared.

A driver database 325 may also be part of the data server 320. Because so many devices are connected in the system, they may require drivers to communicate with one another. Usually drivers may be pulled from the internet, but having the necessary drivers stored in their own database may save time and network resources. A driver for any of the devices that make up system 300 may be obtained from a network and stored locally in driver database 325 until the driver is required again.

A statistics engine 326 may also be part of the system 300. A statistics engine 326 may be a combination of hardware and software capable of performing analyses on the data stored in other parts of the data server 320. The statistics engine 326 may perform operations on data collected before, during, and after a training session to find correlations and assist in generating reports about users. A computing device running R commander (Rcmdr) is one example of a statistics engine. The statistics generated may be unique to a particular individual taking part in a session, scenario or experience. Alternatively, the statistics may be based upon groups and/or anonymized to describe the responses of a group of people as an average or median.

A report generator 327 may also be part of data server 320. The report generator 327 is an engine capable of taking data from the data server and displaying it to a user or operator in a way that they can meaningfully understand the data. A report generator 327 may generate reports or physical printouts based upon the operation of the statistics engine 326, or a file generated by an Excel® spreadsheet. The reports may be conformed to certain formats such as portable document format or hypertext transfer protocol format when output.

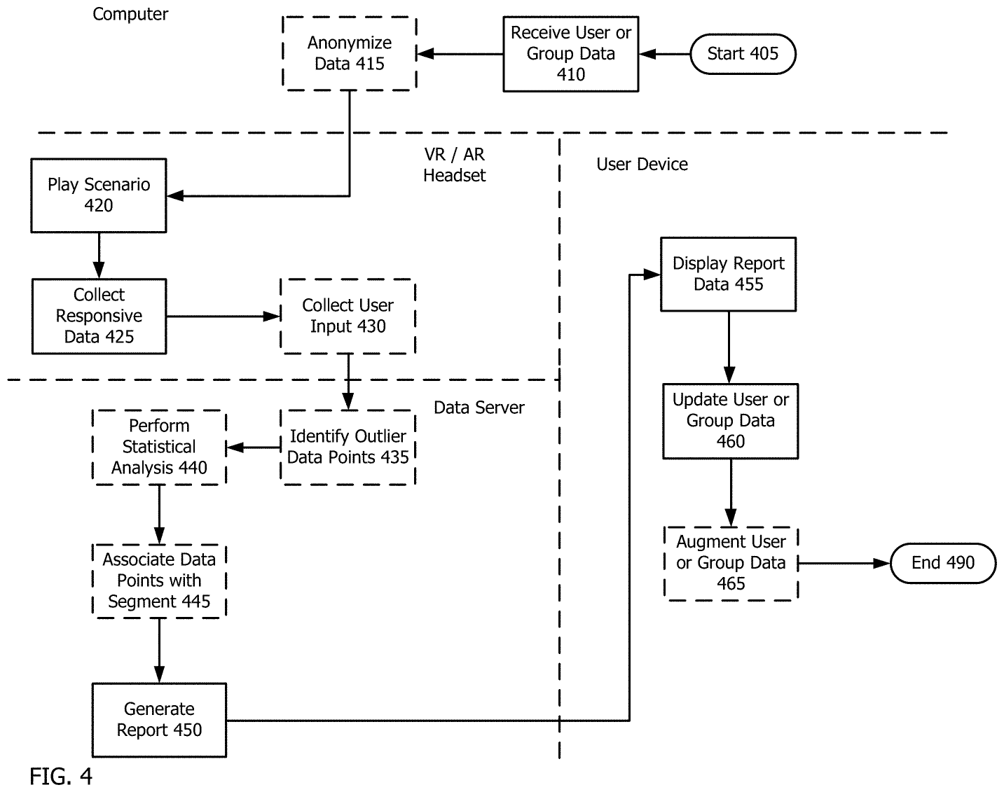

Referring now to FIG. 4, a flowchart for a process of scenario generation is shown. Note, some steps in this figure may be repeated or omitted depending on user preferences. The process may start at 405 when an operator, such as a human resource employee or executive in an organization begins the process of initiating a scenario or experience for a user. If data regarding the user or users who will undergo training is available or was previously generated, it may be received as group data at 410. This data may be generated within a VR/AR headset, but may also be generated separately before or after a session or, in some cases, both. This data may be generated, for example, through the use of a web-based, tablet PC-based, or mobile device-based test or review process. Following a given session, further data may be generated by similar systems or processes (at 460, see below).

Group data may be any information about users about to partake in the training such as past questionnaires, personality tests, integrity tests, employment data, social media data, statistics created while a user has been at work, and any metadata collected about a user. The data may be digital or not but should be converted to digital data if used. In some instances, the data may be narrowly tailored to the training session such as data from previous training sessions, or data from quizzes and tests used to assess a particular type of sensitivity or bias. In other instances, the group data may appear to have no correlation with data collected later on in the training session, but that correlation may become relevant after the scenario or experience is completed.

There are a multitude of tests that may be used including results from the Gender-Career Implicit Association Test (IAT), or other demographic-specific Implicit Association Tests, the Gender-Work Issues Test, as well as other types of tests. These tests may be taken several times, sometimes before the training session or after and the results may then be compared. Sometimes, non-narrowly tailored data is still important because later on it can be used to find useful correlations that will help an organization. For example, if non-narrowly tailored data is paired with the collected response data collected at 425, after a statistics engine performs mathematical operations to it such as machine learning algorithms and linear regression, useful correlations may be found. Such useful correlations could include unusual data such as employees that come to work after 9:00 am show more respect to coworkers, employees that spend more time on social media tend to be less respectful, or employees in Group I are more respectful than those in Group II and so on.

At 415 the user or group data may be anonymized. Employers may want data anonymized because users may be inclined to give more honest responses or honest interactions if they know nobody can trace the data they provide back to their true identify. Anonymizing data can take many forms such as redacting names of users, assigning fake names, assigning numbers to users using a random number generator, or removing or altering other personally identifying information. In other instances, data may not be anonymized, so this step is shown as optional in 415.

After the data has been anonymized at 415 and a user has put on a VR/AR headset the scenario, experience, segment, or training session may begin. Note although start 405, depicts the start in this figure, in other instances a given training session for an individual or group may start at 420, with none of the data collection steps of 405, 410, and 415 taking place beforehand.

At 420, the VR/AR headset generates a scenario for each user. Playing scenarios to the user will be more discussed in the other figures. As the scenario plays, a user may interact with the scenario and sensors or the VR/AR helmet may collect response data at 425. The various sensors described with reference to FIG. 3 may generate various kinds of data that may be collected at 425. At 425 response data is collected from VR/AR headset 310 or auxiliary sensors 340.

Optionally, the system may collect user input at 430. User input may include times when a user is specifically asked to do something such as answer a multiple choice question, answer yes or no, provide a vocal response which may be detected and parsed by the system, or otherwise engage with a VR/AR character (e.g. shake hands, wave, etc.). User input data may be thought of as data that must be collected from an action a user takes on their own volition. User input data may be created by participant questions or using a controller during a training session. For a given user, after all of the data is collected and the scenario has ended, the process may end.

The data collected in steps 425 and 430 is eventually passed to a data server where a data server identifies outliers and data points at 435. Statistical analysis is then performed at 440. Statistical analysis can take many forms. For example, haptic data collected from sensors can be used along with linear regression to see if there is a correlation between heartbeat at awkward moments in a scenario and an amount of sensitivity in a user to a given scenario or a portion of a scenario. Users in a group experiencing a scenario played at 420 can also be ranked based on responses and who responded the best or who may require additional sessions.

At 445, data points may be associated with segments from the scenario of 445. For example, a correlation could be found that at segment 3:18-3:50 of the scenario played at 420, users began to sweat more and become more agitated because a VR character was suffering from bias. The correlation in this segment may be to an unfortunate episode of a physical altercation based upon an interaction between a male and female colleague. A given user's physical reaction may be correlated to that segment and to other segments which may be differentiated on a timeline of a given scenario.

Once the data has been processed a report may be generated at 450. The report may be for an individual user, for a group of users, or both. The report can be customized based on the needs of the individual, the entity, or organization using the training session. Sometimes the report may include information about a test a user has taken before. For example, if a user took an implicit bias test before undergoing a training session, the report may have the user's score on the implicit bias test, along with data related to the training session. If a user took an implicit bias test more than once on various occasions, the report may display the scores and indicate whether there has been improvement after undergoing a training session.

Next the report is displayed to a user at 455. The user may be the same user as in 420, or an organization the individual is associated with (e.g. an HR professional) or both. If a group underwent the training together, data may be tracked for the whole group and individuals, the data can be updated at 460. This could be training in a group session with multiple simultaneous participants. In most situations, this training may be a sequential training or asynchronous training of multiple individuals moving through the same or similar content. The data can also be augmented further by associating group data from one study with others or from a series of repeated training sessions over time. Thereafter, the process ends at 490.

This process is broken up between several different devices labelled as computer, VR/AR headset, data server, and user device. Some or all of these devices may be merged or may be the same device. This breakdown is shown only as an example for illustrative purposes for an example of the system.

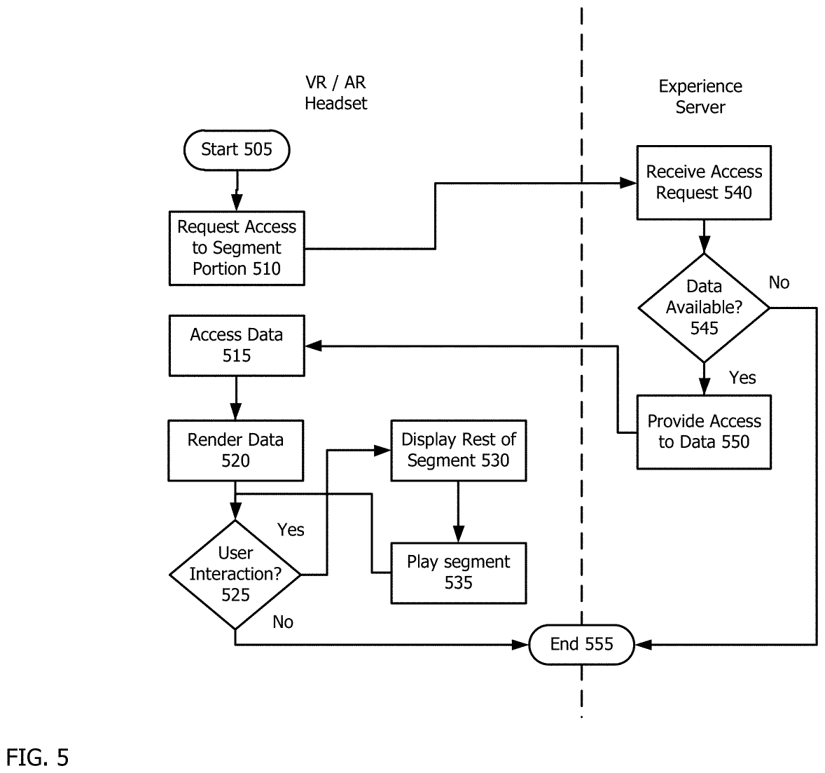

Turning to FIG. 5, a flowchart for a process of interaction between a VR/AR headset and an experience server is shown. The system starts at start 505 when a user puts on a VR/AR headset and ends when the session is over at end 555. The flowchart is described with respect to a particular segment (sub-part of an overall scenario or experience), but may take place many times until an entire scenario or experience is completed.

The headset first requests access to a particular segment portion at 510 to begin the training session. The visualization server has data regarding different types of training sessions, the scenarios associated with them, and segments associated with them. A scenario is a type of training session. For example, say someone wanted to engage in a training session that focused on seeing the point of view of the opposite gender the scenario from the experience server would likely involve seeing a workplace related function from the point of view of a woman, man, or differently-identifying person.

A particular segment would be a piece of the scenario making up the training session. So, in the example of a workplace, one segment may relate to a meeting in which the user, from a woman's perspective, is giving a report and being ignored by her male colleagues, a second segment may be the woman speaking to another man at the watercooler. The third segment may be a woman speaking to another woman and so on and so forth. Segments, scenarios, and training sessions can also come in different versions. A version may be a segment with various attributes of the user or others in the scenario changed. Attributes that may be changed include, race, ethnicity, sex, gender, age, height, weight, sexual orientation, gender identity (characteristics such as binary, or non-binary, transgender, cisgender), social or economic or other background, socioeconomic status, religious beliefs, a personality characteristic, a disability, classification of job (such as blue collar or white collar), the type of work (such as STEM-related versus artistic), national origin or a variable attribute. Variable attributes include attributes that may be loaded later such as whether the person belongs in a particular gang, whether a person is from a gentrified neighborhood or not. Other characteristics are also possible.

Once the VR/AR headset has made a request for access to a segment portion, the request is passed to the experience server. At 540 the experience server receives the access request. At 545 the experience server checks to see if data relating to the segment is accessible. This may be a test to determine if the particular user has authorization to access that data as well as to determine whether the data is available (e.g. is a membership or entrance fee paid, or is a predecessor segment required to be viewed before viewing this particular segment). Data may include both the segment itself such as an MP4 file and data relating to the segment such as questions associated with the segment or haptic data collected from other users regarding the segment. If no such data is available, the process ends at 555.

If data is available, the access to the data is provided at 550. This data provision at 550 may initiate a download of the segment, or merely unlock a previously-downloaded segment already available and stored on the VR/AR headset. Alternatively, the scenario may be streamed in real-time from the experience server.

Once access is granted by the experience server, the data is accessed by the headset at 515. The data is then loaded into a computing portion of the VR/AR headset for viewing and display, and the data is rendered at 520. And displayed rendering data includes playing the files on the VR/AR headset and presenting them to the user. The playing may be a 360- or 180-degree video playback or may be a fully-immersive video-game like virtual reality experience. Regardless, rendering data also includes displaying potential questions and interactions to the user.

Next, the user may be presented with a user interaction 525. A user interaction is a part of the training session in which a user must interact with the VR/AR environment on their own volition. This can include answering questions in a yes-or-no, true/false, or multiple-choice format. It also includes giving voice commands through the AR/VR environment, or looking in a certain direction, eye or hand movement, or any other form of movement that may generate a signal the VR/AR system can record and associate with an interaction.

If the answer to 525 is yes, then the rest of the segment at 530 is played. Certain segments may require certain actions to proceed or may even change based on answers given by a user. The segment may then be played at 535. When all of the segment has been played and the data recorded the process ends at 555. Additional segments making up the entire scenario may be played in much the same way as shown in FIG. 5.

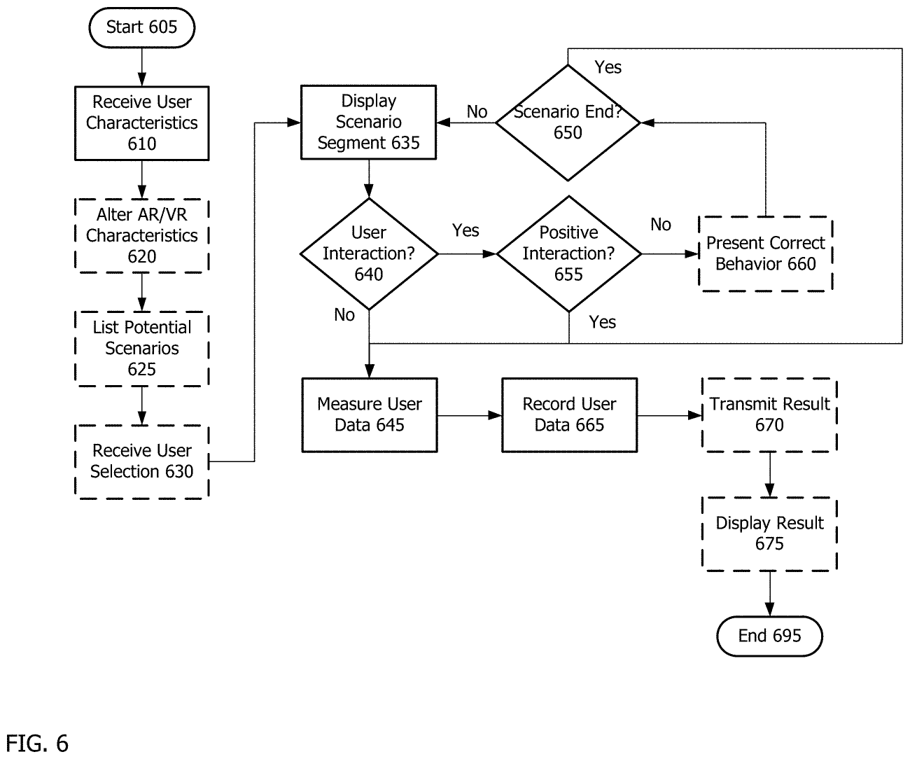

Turning to FIG. 6 a flowchart for a training session is shown. Here, a flowchart of a potential training session in which a user's characteristics heavily influence the characteristics of the training session. Often these training sessions will be used to teach about sensitivity, diversity, inclusion, differences in cultures, sexual harassment, and other topics that are often difficult to understand from a single point of view. For example, a male may have a hard time understanding—without being in the perspective of a female—that something said to a female may be hurtful or interpreted as disrespectful.

Following the start at 605, and proceeding until the end at 695, the process begins at 610 when a user puts on an AR/VR headset. At 610, the system may receive characteristics about the user. These include the actual characteristics of the user such as the user's real skin color, age, height, race, and other attributes listed previously and throughout the specification. These may be relevant to the operation of the system or a particular scenario. These characteristics may be inputted within the VR/AR headset, may be pre-selected by a user or an operator before the headset is put on (e.g. in a web-based or software-based form), or may be provided by an HR manager or other employer representative).

At 620, the user will be given the option of altering characteristic about themselves in the AR/VR environment or other attributes about the training session. Or, this process may take place automatically (e.g. digitally changing a white male into an Asian female, or an able-bodied person into an individual with a disability). Attributes include those listed above and throughout. This process is optional because the characteristics may have been chosen for the user before this process began.

The system may then move on to 625 where a user may be presented with a list of potential scenarios. This is listed as optional as well because the scenarios may be pre-selected for the user by an operator. These scenarios may include what was listed above and others such as workplace environment, a school environment, a cultural environment, a person's homelife, a different country, or similar scenes but from a different point of view.

At 630, the system receives a user selection regarding the options listed in 620 and 625. Inputs may be given through a controller, keyboard, or by movements of the AR/VR display. This step is again optional because an operator may have selected the scenario and characteristics for the user beforehand.

At 635, the system displays to the user a scenario segment. In FIG. 6, the segment may contain an interactive component to which a user will be expected to give a signal. However, in other versions, a user will simply be observing the segment and there will be little to no interaction. The process then moves to 640 where the system detects if there has been a user interaction. There may be pre-determined places within the scenario where a user is expected to interact. Or, alternatively, interactions may be enabled throughout. User actions have been discussed previously but other peripherals may be used by a user to transmit a signal relating to a user interaction. Additionally, the VR/AR headset may be equipped with auxiliary sensors or other auxiliary sensors may be used that collect data from the user.

If there is a user interaction (“yes” at 640), then a determination may be made whether that interaction was positive or negative at 655. Some situations may not be reducible to either a “positive” or “negative” interaction, but for purposes of training, many may be. If it cannot be, the interaction may merely be noted for recording and analysis later.

At 655 some user interactions can be broadly divided into positive interactions and not positive interactions. Every training session will likely have a goal or lesson it is trying to measure or even bestow on the user. These lessons and goals may be bestowed or measured based on how well a user applies the lesson in a scenario based on the interactions the user gives. For example, say a training session is trying to teach a user to speak out when they witness an injustice rather than do nothing. An interaction would be considered to be positive if, after a segment showed an injustice to the person whose perspective the user is experiencing, the user selected an option, when presented, that intervened. A not positive interaction would be any option that was not intervening.

If the interaction is not positive (“no” at 655), then the correct behavior may, optionally, be presented to the user at 660. This may mean replaying the segment until a positive result is reached, or may mean showing the user the correct, positive response and the associated reaction to that response after showing the negative (not positive) response. In either case, the scenario may play out over the course of a minute or so in response to the input, either positively or negatively for the user.

Then, a determination of whether the scenario has ended or not is made at 650. If so (“yes” at 650), then the process continues at 645. If not (“no” at 650), then the next scenario segment is shown at 635.

If the interaction is positive (“yes” at 655), then the input data may be measured at 645. This may be as simple as recording the yes or no answers or other responses to a given segment or scenario. This may be as complex as recording electrode and eye tracking data from the auxiliary sensors. Whatever data is available and relevant may be measured at 645 and recorded at 665.

The recording may take place by the AR/VR helmet itself, an experience generator, a web server, or any other computing device. In other instances, the user data may be converted to a result and transmitted to a user at 670. The transmitted results may then be displayed in the form of a report or raw data. Both of the steps 670 and 675 are optional because a given user may not see a report or other result when taking part in a scenario. The report may be only made available in some cases to the administrator or operator (e.g., an employer). However, in most cases, the report will be made available to the user as well. The process then ends at 680. Note although FIG. 6 primarily shows interactions from the user, in other embodiments another person besides the user (HR Staff, software engineer, boss etc.) may program or direct the selections of 620 to 630 and may receive the results at 670 and 675.

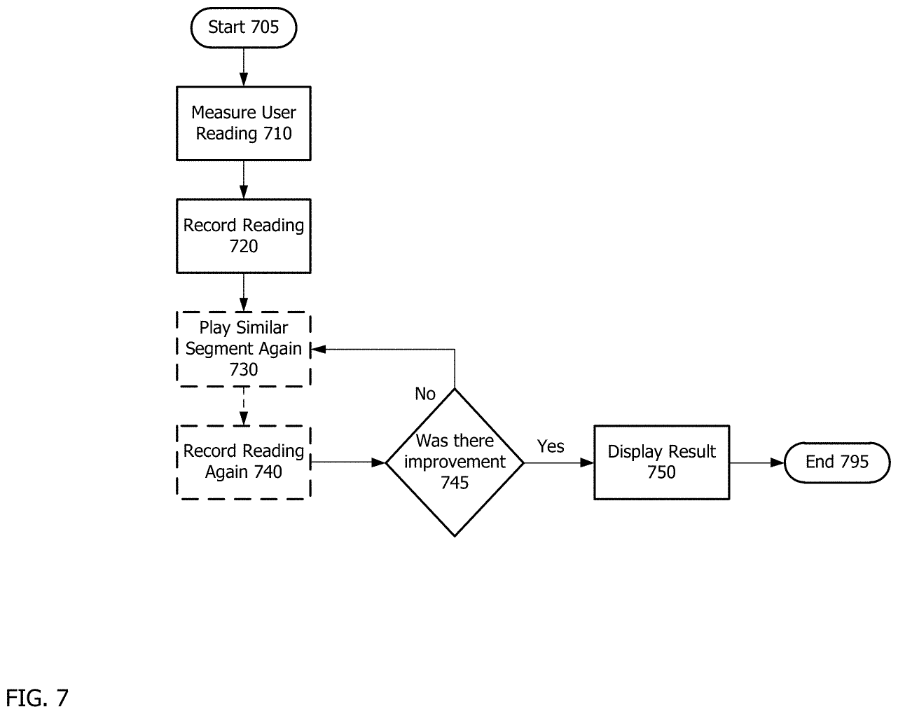

Turning to FIG. 7, a flowchart for user interaction and feedback is shown. The process begins at 705 and ends at 795. This figure is intended to be a more detailed description of how a user's interaction with the system may provide feedback that more narrowly tailors how the system displays scenarios seeking improvement in a user. The process starts when a user puts on an AR/VR helmet and begins a training scenario while viewing and interacting with a segment at 705.

At 710, a haptic sensor of the AR/VR device measures a user reading. A user reading can include, pulse oximetry, heartbeat, pulse skin conduction, EKG, EEG, hormone levels, breathing, eye movement, eye location, blood data, and any other data that may be picked up by sensors placed on a user's body. The reading may be a score of a user's responses to the inquiries. The reading may be the results of a sensitivity test. Regardless, the reading is then recorded at 720. The recording may take place on the device itself, or the experience database, a database or any other computing device. The reading may be a response to a particular segment or scenario.

Moving to 730, the process may play a similar segment to the user again. Note that a “similar segment” may be the exact same segment as whatever was played in 710 or be a slightly different segment with a similar goal or focus. The determination of whether a segment is similar to another is based entirely on the training session and those who have designed the training session. These are likely the creators of the scenarios themselves, which may focus on training for a particular characteristic or set of undesirable actions. However, selections among the available options may be made by an operator or even the user of the system in some cases. For example, take teaching about how to speak out in a group of people. One segment may display someone being treated nastily in a meeting, while another, similar segment shows a different group of people treating a different person nastily next to a water cooler. In another training session, two similar segments may be determined to be similar because the same group of people are all interacting across different settings. What is deemed similar is entirely based on what lesson a particular training session is trying to teach, and who has planned or directed the session.

Once the second segment has been played at 730, a new reading may be recorded at 740. Preferably, this will be the same type of reading as was recorded in 720 but this time, the reading may be different in response to the training session.

Next, the process checks at 745 for improvement. Whether or not improvement is measured can be determined in one of two ways. The first way is whether the two readings (at 740 and 710) are the same. Then a simple number comparison is performed to see if the reading at 710 is either lower, the same, or higher than 740. A second type of improvement may be entirely operator determined. For example, an operator may measure skin conduction at 710 and then heartbeat at 740. The operator may also have his or her own personal determination for improvement (e.g. if there was a high skin conduction at 710, but a low heartbeat at 740 that marks improvement, but if there was a normal skin conduction at 710 and high heartbeat at 740, this is not improvement). Another type of improvement may be detected externally through use of independent testing or personality testing, or sensitivity testing and the like. If so, the improvement testing may take place over many weeks or months. Generally, repetition tends to reinforce the training, so this may be advisable. If improvement is measured at 745 (“yes” at 745), then the process may be complete, and the results may be displayed at 750. The process ends at 795.

If there was no improvement or inadequate improvement (“no” at 745), then the process may repeat with a similar segment at 730. The process may then end at 795 upon satisfactory improvement.

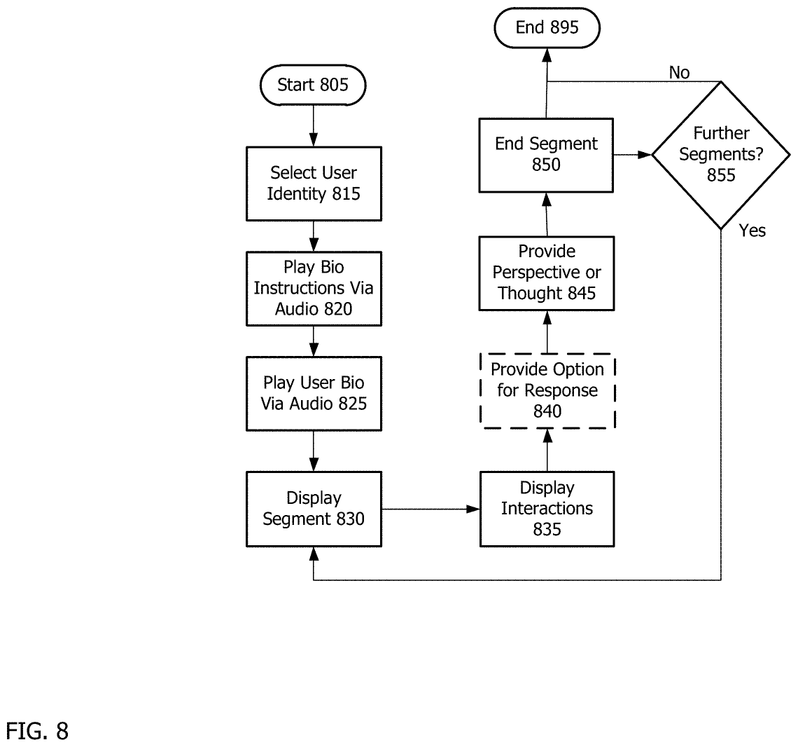

Turning to FIG. 8, a flowchart for a training session with limited to no user interaction is shown. Here, we see a flowchart of a training session with limited to no user interaction. The process begins at 805 when a user puts on a VR/AR headset and the training sessions starts.

First, at 815 a user may select a user identity. A user identity can include race, ethnicity, sex, gender, age, height, weight, sexual orientation, gender identity (characteristics such as binary, or non-binary, transgender, cisgender), a social or economic or other background, socioeconomic status, religious beliefs, a personality characteristic, a disability, classification of job (such as blue collar or white collar), the type of work (such as STEM-related versus artistic), national origin, political party, and many more. Although in FIG. 8 the user selects the user identity, in other instances the operator or another person may make the selection.

Next, the process moves to 820 in which a user is given instructions on their identity and the overall scenario process. These instructions may be given via audio as they are in 820 or other means such as words displayed via an AR/VR helmet. Note a user's identity selection may be inverted or at the very least different from those of the actual user. For example, if a CEO or executive enters a training session, they will likely be depicted as a janitor or office employee. If a white male enters a training session they may be depicted as a black man or woman in the AR/VR environment. The point is to give the user a different perception of others' thoughts, experiences and senses, compared to what a user is accustomed to in real life. Though, in some cases, individuals may be able to view and experience, if they would like, scenarios that may have been specifically designed for others.

A segment is then displayed to the user at 830. The scenarios in FIG. 8 may appear somewhat formulaic as they follow a specific pattern. At 835 an interaction is displayed. Note this is not the same as the user interactions that have been discussed but an interaction between either a non-user person appearing in the AR/VR world with another person appearing in the AR/VR world or the user.

In some instances, the user may be given an opportunity to provide a response as in 840. In other instances, the user may be presented with an audio thought. An audio thought is a thought that the user may have after viewing the interaction of 835. For example, if a white male is the user identified at 815, but in the AR/VR world is now a black man, the perspective thought of 845 would correspond to the provided identity at 845—in this case, a black male.

A determination is then made whether there are further segments for this user at 855. If not (“no” at 855), then the process ends at 895. If there are further segments (“yes” at 855), then the process continues with displaying of the next segment at 830. Once all the segments have been played the process ends at 895.

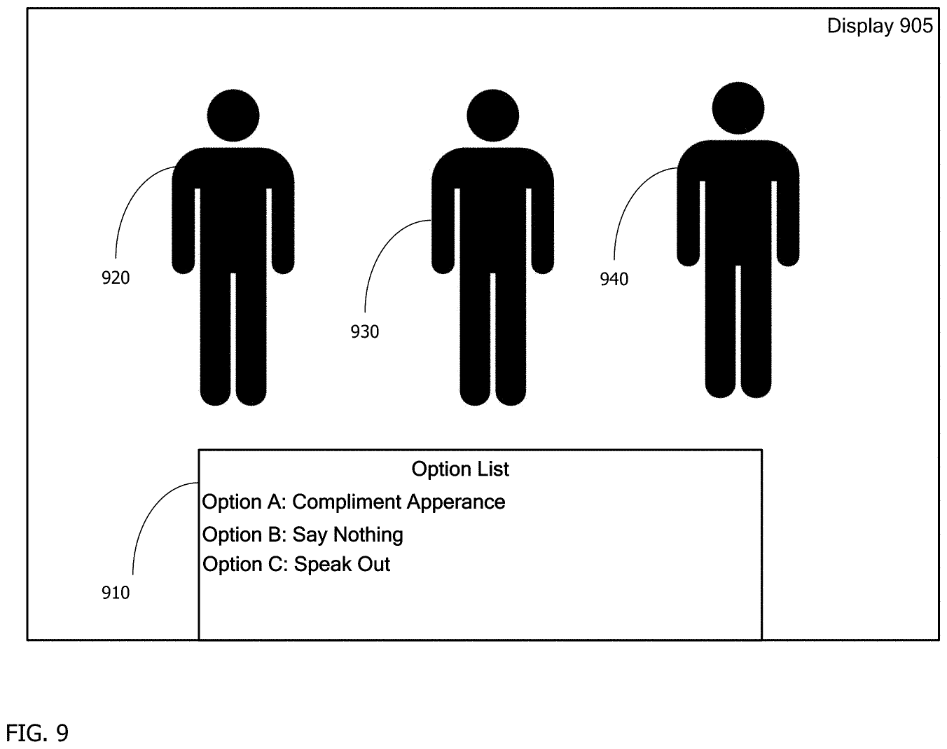

Turning next to FIG. 9, an example user interface is shown. Here, we see a user interface of what a user may see when looking through a VR/AR helmet. Display 905 is likely a screen within an AR/VR helmet that a user may be looking at, but may be on a television or other display. In this instance the user is presented with interaction options at 910. The options consist of a multiple-choice question, but could have also been yes-or-no responses. The options also could consist of other measurable actions such as raising a controller to simulate hand movement, or eye gaze or head movement, or standing, or a spoken response. The user here also sees virtual reality objects 920, 930, and 940. These objects in this instance are other people that the user may interact with or witness engaging in some sort of activity. But other objects are also possible.

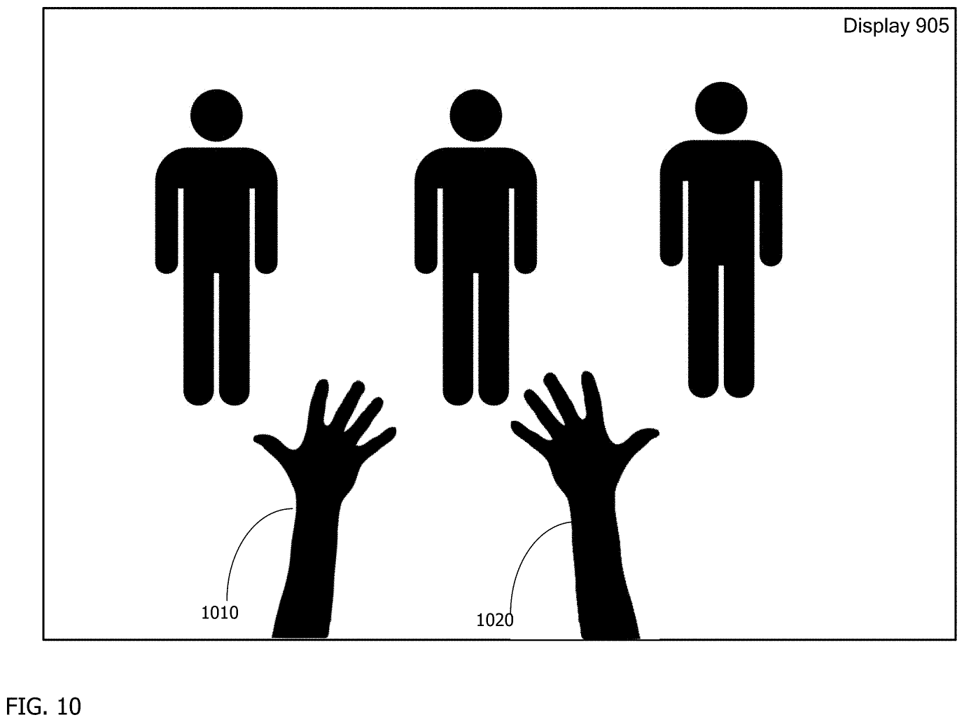

Turning to FIG. 10, a different example of the user interface is shown. In this user interface the user may see their own virtual hands 1010, and 1020. Note that based on a training session and scenario that a user is placed in, the type of virtual hands 1010 and 1020 may change. For example, if a user is white in real life, but the training session and scenario dictates that the user will virtually be a black man, then hands 1010 and 1020 may be actually depicted as a black person's hands. Other characteristics may also be simulated within the virtual space. And, movement in reality may be linked to movement of those same hands or body in the virtual or augmented reality space using trackers. Such characteristics help to convincingly simulate the scenario as from another's perspective. Similarly, if the training session and scenario dictated that the user will virtually be a woman, then the hands depicted in 1010 and 1020 may appear to be those of a woman.

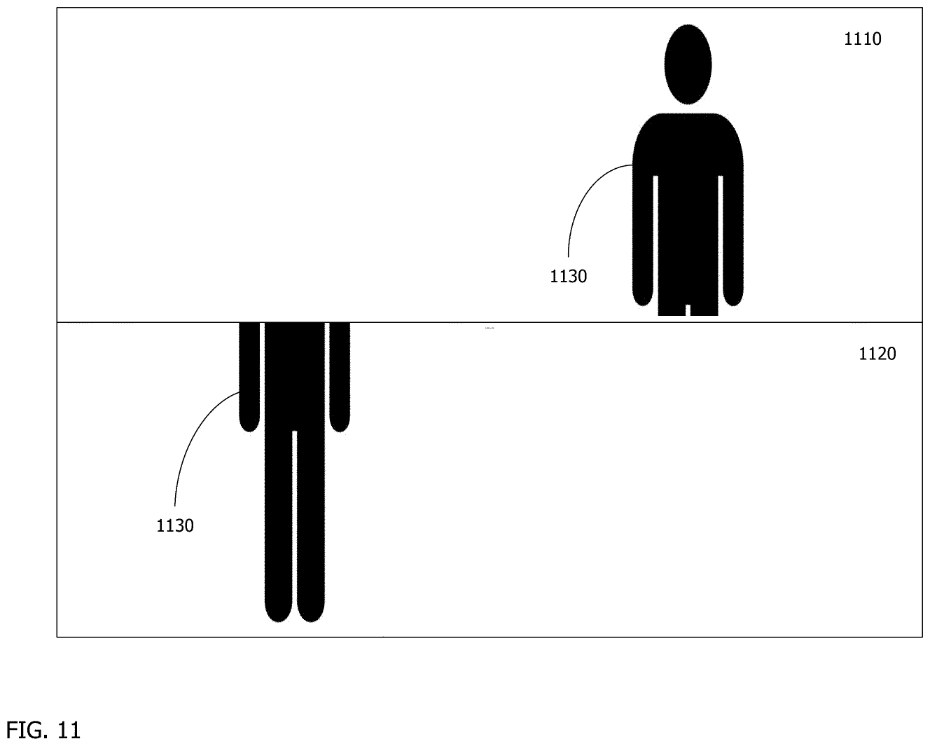

FIG. 11 is a comparison of different perspectives in a training session. A split screen view of two different perceptions, perception 10, and perception 20 are shown. Note, no one particular user will see 10 and 20 together, the images have been combined into one figure for ease of reference and to show an intended contrast. The user in 10 may be a male that is tall, tall enough that when looking at another virtual male 1130, he is at eye level with them. Another user seeing view 20 may be a shorter male, or a shorter woman. The individual may also be in a different part of the room and in a sitting position when compared to the user viewing 10. The user seeing the view in 20 would thus see a different part of the virtual person 30 in the picture. This image demonstrates how users experience the standpoint of different virtual users (e.g. male vs. female, sitting in a meeting vs. standing during the meeting, someone “looming over” another, or simply standing nearby) may see different things when using the system and be exposed to different points of view.

These and many other scenarios may play out within the virtual space such that a user may be introduced to new perspectives.

A client computer may include software and/or hardware for providing functionality and features described herein. A client computer may therefore include one or more of: logic arrays, memories, analog circuits, digital circuits, software, firmware, and processors such as microprocessors, field programmable gate arrays (FPGAs), application specific integrated circuits (ASICs), programmable logic devices (PLDs) and programmable logic arrays (PLAs). The hardware and firmware components of the client computer 100 may include various specialized units, circuits, software and interfaces for providing the functionality and features described here. The processes, functionality and features may be embodied in whole or in part in software which operates on a client computer and may be in the form of firmware, an application program, an applet (e.g., a Java applet), a browser plug-in, a COM object, a dynamic linked library (DLL), a script, one or more subroutines, or an operating system component or service. The hardware and software and their functions may be distributed such that some components are performed by a client computer and others by other devices.

Although shown implemented in a personal computer, the processes and apparatus may be implemented with any computing device. A computing device as used herein refers to any device with a processor, memory and a storage device that may execute instructions including, but not limited to, personal computers, server computers, computing tablets, set top boxes, video game systems, personal video recorders, telephones, personal digital assistants (PDAs), portable computers, and laptop computers. These computing devices may run an operating system, including, for example, variations of the Linux, Microsoft Windows, Symbian, and Apple Mac operating systems.

The techniques may be implemented with machine readable storage media in a storage device included with or otherwise coupled or attached to a computing device. That is, the software may be stored in electronic, machine readable media. These storage media include, for example, magnetic media such as hard disks, optical media such as compact disks (CD-ROM and CD-RW) and digital versatile disks (DVD and DVD±RW); flash memory cards; and other storage media. As used herein, a storage device is a device that allows for reading and/or writing to a storage medium. Storage devices include hard disk drives, DVD drives, flash memory devices, and others.

### CLOSING COMMENTS

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A system of presenting an individual with an experience from a perspective of an other individual, the system comprising:
a computing device for generating a virtual reality environment for the individual, the virtual reality environment including at least one scenario from the perspective of the other individual, the perspective including a characteristic that is different from a corresponding characteristic for the individual; and
a head mounted display device further for displaying to the individual the virtual reality environment.

2. The system of claim 1 wherein the characteristic of the user includes at least one of a race, ethnicity, sex, gender, age, height, weight, sexual orientation, gender identity (characteristics such as binary, or non-binary, transgender, cisgender), a social or economic or other background, socioeconomic status, religious beliefs, a personality characteristic, a disability, classification of job, the type of work, national origin, or a variable attribute.

3. The system of claim 2 wherein the computing device is further for:
generating choice selections for the individual within the virtual reality environment based in part on the characteristic;
receiving a selection from among the choice selections within the virtual reality environment; and
altering the virtual reality environment based on the selections from the user.

4. The system of claim 1 wherein the computing device is further for:
measuring an initial reading of at least one measurable variable of the individual before presenting the at least one scenario to the individual;
taking a second reading of the at least one measurable variable of the individual; and
storing the initial reading and the second reading;
wherein the handheld display device is further for presenting at least one scenario to the individual.

5. The system of claim 4 wherein the computing device is further for:
comparing the initial reading and the second reading; and
indicating improvement if the initial reading and the second reading demonstrate a positive reaction related to the characteristic.

6. The system of claim 2 further wherein a response from a virtual individual within the virtual reality environment is based upon the selection.

7. The system of claim 6 where:
the computing device is further for advising the individual within the virtual reality environment of an appropriate choice selection; and
the head mounted display device is further for showing the individual a preferred response of the virtual reality individual to the appropriate choice.

8. The system of claim 2 further comprising an eye tracking sensor for performing periodic eye tracking of the individual within the virtual reality environment; and
wherein the computing device is further for storing the periodic eye tracking data in conjunction with a timestamp indicating a time position within the scenario.

9. The system of claim 3, wherein the selection is made using movement of the individual and overlays of body parts of the other individual are overlaid in place of the corresponding body parts for the individual as the selection is made.

10. The system of claim 3 wherein a subsequent scenario within the virtual reality environment is altered based upon the selection made by the individual within the at least one scenario.

11. The system of claim 4 wherein the computing device is further for:
aggregating the at least one measurable variable for multiple individuals; and
storing a report including the at least one measurable variable for the multiple individuals.

12. A method of presenting an individual with an experience from a perspective of an other individual comprising:
generating a virtual reality environment for the individual, the virtual reality environment including at least one scenario from the perspective of the other individual, the perspective including a characteristic that may be different from a corresponding characteristic for the individual; and
displaying to the individual the virtual reality environment.

13. The method of claim 12 wherein the characteristic of the user includes at least one of a race, ethnicity, sex, gender, age, height, weight, sexual orientation, gender identity (characteristics such as binary, or non-binary, transgender, cisgender), a social or economic or other background, socioeconomic status, religious beliefs, a personality characteristic, a disability, classification of job, the type of work, national origin, or a variable attribute.

14. The method of claim 13 further comprising:
generating choice selections for the individual within the virtual reality environment based in part on the characteristic;
receiving a selection from among the choice selections within the virtual reality environment; and
altering the virtual reality environment based on the selections from the user.

15. The method of claim 12 further comprising:
measuring an initial reading of at least one measurable variable of the individual before presenting the at least one scenario to the individual;
presenting the at least one scenario to the individual;
taking a second reading of the at least one measurable variable of the individual; and
storing the initial reading and the second reading.

16. The method of claim 15 further comprising:
comparing the initial reading and the second reading; and
indicating improvement if the initial reading and the second reading demonstrate a positive reaction related to the characteristic.

17. The method of claim 13 further wherein a response from a virtual individual within the virtual reality environment is based upon the selection.

18. The method of claim 17 further comprising:
advising the individual within the virtual reality environment of an appropriate choice selection; and
showing the individual a preferred response of the virtual reality individual to the appropriate choice.

19. The method of claim 13 further comprising:
performing periodic eye tracking of the individual within the virtual reality environment; and
storing the periodic eye tracking data in conjunction with a timestamp indicating a time position within the scenario.

20. The method of claim 14 wherein a subsequent scenario within the virtual reality environment is altered based upon the selection made by the individual within the at least one scenario.
